(19) United States
(12) Patent Application Publication
(10) Pub. No.: US 2006/0220918 A1
(43) Pub. Date: Oct. 5, 2006

(54) Rotating seal for anti-stiction of hydraulic struts

(76) Inventors: Daniel Stockwell, Woodinville, WA (US); Igal Goniodsky, Kirkland, WA (US)

Correspondence Address: FULWIDER PATTON, 6060 CENTER DRIVE, 10TH FLOOR, LOS ANGELES, CA, 90045, US

(21) Appl. No.: 11/391,802

(22) Filed: Mar. 29, 2006

Related U.S. Application Data
(60) Provisional application No. 60/667,723, filed on Mar. 30, 2005.

(51) Int. Cl. G08B 21/00; B64C 25/00

(52) U.S. Cl. 340/960; 244/100 R

(57) ABSTRACT

An onboard system for use in measuring, computing and displaying the weight and center-of-gravity for aircraft, while keeping aircraft movement to a minimum. Pressure sensors are mounted in relation to each of the landing gear struts. A motor and rotating seal are configured into each strut and are activated by a computer/controller, while landing gear strut pressures are monitored in the determination of strut stiction. The computer/controller calculates the stiction of each landing gear strut and compensates for the pressure distortions caused by landing gear strut stiction. Additional features include reducing strut stiction, measuring landing gear strut fluid levels, monitoring landing gear strut health, weight adjustments for external ice and de-icing fluids, weight adjustments for wind, monitoring aircraft landing gear strut movement.

### CROSS-REFERENCES TO RELATED APPLICATIONS

This application is based upon provisional application Ser. No. 60/667,723 filed on Mar. 30, 2005.

### FIELD OF THE INVENTION

This invention is related to determining the load on aircraft struts.

### BACKGROUND OF THE INVENTION

Two critical factors in the flight of any aircraft are the weight and balance of that aircraft. This is to insure that at take-off speed, the wings are generating sufficient lift to lift the weight of the airplane. An equally important factor to consider is whether the airplane is in proper balance (center of gravity) or within acceptable limits, as can be compensated for by trim adjustments.

The weight of an aircraft is supported on a plurality of collapsible landing gear struts. These landing gear struts contain pressurized hydraulic fluid and nitrogen gas. The pressure within each landing gear strut is related to the amount of weight that landing gear strut is supporting. Multiple O-ring seals within the landing gear strut are used to retain the hydraulic fluid and compressed nitrogen gas contained within each landing gear strut. The retention of the compressed nitrogen gas and hydraulic fluid by the O-ring seals is due to the extreme amount of friction these seals maintain as they move up and down the cylinder walls of the landing gear strut. This friction (defined in the aircraft strut industry as “stiction”), while it may improve the shock absorbing quality of the landing gear strut, distorts internal landing gear strut pressures, as those pressures relate to the amount of weight the landing gear strut is supporting. Compensations are needed to correct for distorted pressure readings caused by the stiction within these landing gear struts in order to accurately determine the aircraft weight.

Previous systems to determine gross weight and center of gravity are well known and well documented. Reference may be made to U.S. Pat. No. 3,513,300 Elfenbein, U.S. Pat. No. 3,581,836 Segerdahl, U.S. Pat. No. 5,521,827 Lindberg et al, and, U.S. Pat. No. 5,214,586 and U.S. Pat. Nos. 5,548,517 and 6,293,141 to Nance.

U.S. Pat. No. 3,513,300 Elfenbein, identified the relationship between aircraft weight and the pressure within the landing gear struts. Elfenbein pioneered the art of measuring landing gear strut pressure and relating it to the amount of weight supported. The Elfenbein prior art does not compensate for landing gear strut pressure distortions caused by strut stiction.

U.S. Pat. No. 5,521,827 Lindberg et al, continues the Segerdahl and Nance (to be described below) prior art on the identification of friction as a factor causing errors in the direct relationship between the pressure within the landing gear struts and the aircraft weight. Lindberg teaches the practice of multiple hydraulic fluid injections raising each landing gear strut to near full extension and multiple hydraulic fluid withdrawals lowering each landing gear strut to near full collapse. While these extreme up and down movements, raising and lowering the aircraft as much as 2-3 feet, may offer some relief to the potential errors in the prior art taught by Segerdahl, such extreme aircraft movement is incompatible with today's aircraft loading procedures which utilizes a floating passenger “jet-bridge” adjacent to the aircraft door and baggage loading conveyor belts which extend directly into each of the aircraft's cargo compartments. Extreme aircraft movement could cause severe damage to the aircraft or injuries to passengers if the Lindberg practice were to be used during the aircraft loading process.

The Nance technology (U.S. Pat. No. 5,214,586 and U.S. Pat. No. 5,548,517), among other things, measures the pressure distortions caused by strut seal friction, then stores that information for future reference in the event the hydraulic fluid injection and withdrawal mechanism is not functioning. This technology incorporates the storage of defined pressure limits to be used in the determination of hard landings by the aircraft. This technology also measures strut fluid temperature and adjusts for pressure distortions caused by changes in temperature.

The prior art methods to eliminate stiction often require a large amount of energy to lift the aircraft body. Furthermore the algorithms for calculating weight are complex. What is needed and has been heretofore unavailable is a simple, low energy system to remove stiction to obtain accurate aircraft weight and balance. The following invention meets that need.

### SUMMARY OF THE INVENTION

The present invention provides a method of obtaining information about an aircraft. The aircraft is supported by a plurality of pressurized landing gear struts. The landing gear struts experience friction at the seals between the piston and cylinder, which is often referred to as stiction. This stiction distorts internal strut pressures as they relate to weights supported by the landing gear struts.

The method comprises rotating the seal between the piston and cylinder to reduce or eliminate the stiction. This method keeps strut movement to a minimum, thereby minimizing aircraft movement, and also minimizes temperature changes and pressure distortions caused by the temperature changes of the respective landing gear strut fluid. Rotating the seal overcomes the static friction on the seal and is replaced by the much smaller kinetic friction on the seal. While rotating the seal on each of the landing gear struts, the pressure within each of the landing gear struts is measured. This measurement may be compared to measurements of the pressure on the struts before and/or after the rotation of the seal. These pressure determinations are used to compensate for distortions caused by strut stiction.

In accordance with another aspect of the present invention, the stiction may be reduced by rotating the seals slightly to lubricate adjoining strut surfaces. This seal rotation typically occurs before weight measurements are made. Such rotation lubricates the seals, thereby reducing stiction, thereby reducing pressure distortions caused by stiction. Reducing the amount of stiction experienced during the stiction measurement process will reduce the error in the final aircraft weight measurement.

In accordance with another aspect of the present invention, the aircraft strut includes a seal between the piston and cylinder which is designed to be rotated about the piston while the piston and cylinder remain fixed. Like conventional seals on aircraft struts, the seal is housed within the cylinder and forms a fluid tight barrier to prevent loss of hydraulic fluid. The seal permits the up and down motion of the piston relative to the cylinder. Unlike conventional seals on aircraft struts, the seals of the present invention are equipped with means to be rotated about the piston. Such means may include gearing or belts or other interface with a motor.

In accordance with another aspect of the invention, the aircraft struts are equipped with a motor which is configured to rotate the seal about the piston. Such a motor may be powered electrically or hydraulically. A motor may be mounted within the cylinder of each strut and include an interface with the rotating seal. Depending on the type of motor electrical and/or hydraulic lines will be included with the strut assembly to power the motor. These electrical and/or hydraulic lines may include ports external to the aircraft so that the motor may be controlled by an external apparatus.

In accordance with another aspect of the invention, the motors on each strut may be configured to rotate the seals quite slowly. This allows the strut piston to float to a state of equilibrium within the cylinder. This equilibrium state has very little, if any, stiction. While the struts are in this equilibrium state the weight of the aircraft may be measured with very little error due to strut friction.

In accordance with another aspect of the present invention, the weight supported by each of the landing gear struts is determined from the compensated pressure determinations and the unsprung weight. Unsprung weight is the weight of those aircraft landing gear components located below the fluid contained within the landing gear strut. The weight of the aircraft is determined from the respective compensated weight determinations. The center of gravity of the aircraft can be determined from the compensated weights. The step of compensating the pressure determinations of the landing gear struts for the distortions caused by strut stiction further includes the step of applying an offset to the weight determinations from each landing gear struts so as to compensate for any asymmetrical stiction of the landing gear struts.

In accordance with another aspect of the present invention, the step of determining the weight of an aircraft occurs while the aircraft is being loaded or unloaded.

In accordance with still another aspect of the present invention, the determined aircraft weight is compensated for errors caused by wind passing across the aircraft wings and generating weight distorting wing lift. Also, the determined aircraft weight is compensated for errors caused by external ice accumulations or external fluids on the aircraft.

The present invention also provides a method of determining a weight of an aircraft, which aircraft is supported by a plurality of pressurized landing gear struts. The aircraft has a portal that is vertically aligned with a loading device, wherein objects can be loaded on and off the aircraft through the portal using the loading device. The method rotates the seals on each of the landing gear struts so as to reduce stiction without changing the vertical configuration of the strut. The vertical alignment of the portal with the loading device is maintained. During the steps of rotating the seals on each of the landing gear struts and maintaining the vertical alignment of the portal with the loading device the pressure within each of the respective landing gear struts is determined. These pressure determinations are compensated for distortions caused by stiction. The weight supported by each of the landing gear struts is determined from the respective compensated pressure determinations and unsprung weight. The weight of the aircraft is determined from the respective compensated weight determinations.

In accordance with another aspect of the present invention, the loading device can be a passenger ramp or a cargo ramp.

The present invention also provides an apparatus for determining the weight of an aircraft. The aircraft is supported by a plurality of pressurized landing gear struts. The landing gear struts experience stiction. The stiction distorts internal pressures as they relate to weights supported by the landing gear struts. The apparatus includes a supply of pressurized hydraulic fluid or an electrical power source for connecting to the ports connected to the hydraulic or electrical lines of the motor. A controller is included with the apparatus to power the motors and rotate the seals on each of the aircraft struts. A pressure sensor is mounted on each of the landing gear struts so as to sense the pressure of fluid therein. An aircraft weight computer is coupled to the pressure sensors. The aircraft weight computer determines the weight of the aircraft from the sensed pressures.

### BRIEF DESCRIPTION OF THE DRAWINGS

Although the features of this invention, which are considered to be novel, are expressed in the appended claims; further details as to preferred practices and as to the further objects and features thereof may be most readily comprehended through reference to the following description when taken in connection with the accompanying drawings, wherein:

FIG. 1 is a view of the lower side of a typical commercial airliner with a tricycle type landing gear, in the extended position.

FIG. 2 is a partial cross-sectional front view of a typical commercial airliner landing gear strut, with enclosed piston, O-ring seals and orifice plate.

FIG. 3 is a view of a typical commercial airliner near typical airport ground support equipment.

FIG. 4 is a schematic view of the invention in accordance with a preferred embodiment.

FIG. 5 is a side view of an exploded pictorial diagram of a typical airline landing gear strut, shown with attached components of another embodiment of the invention.

FIG. 6 is an exploded pictorial diagram of an alternate type of landing gear strut, with attached components of the invention.

FIG. 7 is a cross-sectional view of an aircraft strut having components according to the present invention.

FIG. 8 is a schematic diagram of the onboard computer/controller, of the invention.

### DETAILED DESCRIPTION OF THE PREFERRED EMBODIMENTS

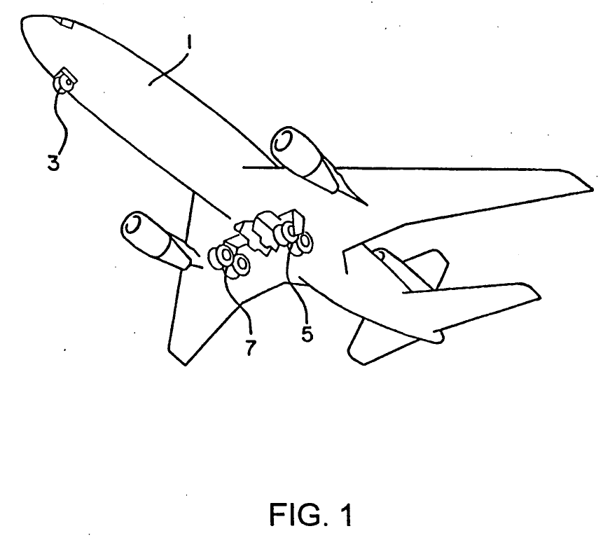

Referring now to the drawings, wherein like reference numerals designate corresponding parts throughout the several views and more particularly to FIG. 1 thereof, there is shown a typical commercial airliner 1 with tricycle landing gear configuration consisting of a nose landing gear 3, port main landing gear 5, and starboard main landing gear 7.

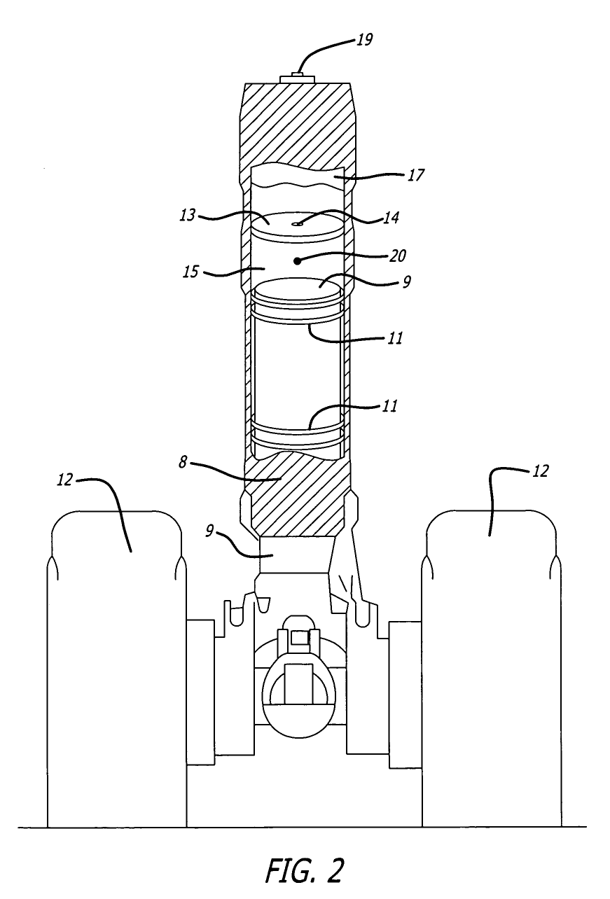

Referring now to FIG. 2, there is shown each conventional and commercially available landing gear 3, 5, 7 (FIG. 1) which consists of one oleo-type shock strut 8, hereafter referred to as “strut,” of which together support the weight of the airplane on tires 12, and an internal cushion of fluid, which also absorbs landing shock. In commercially available struts 8 the fluid includes hydraulic liquid (referred to herein as hydraulic fluid 15) and nitrogen gas 17. Internally each strut contains a forged steel piston 9, with an orifice plate 13 containing an orifice hole 14 that dampens the strut compression motion. O-ring seals 11 serve to retain the hydraulic fluid 15 and compressed nitrogen gas 17 inside the strut cylinder. The strut 8 can be pressurized externally through a nitrogen gas access valve 19. Hydraulic fluid can be accessed through valve 19 as well.

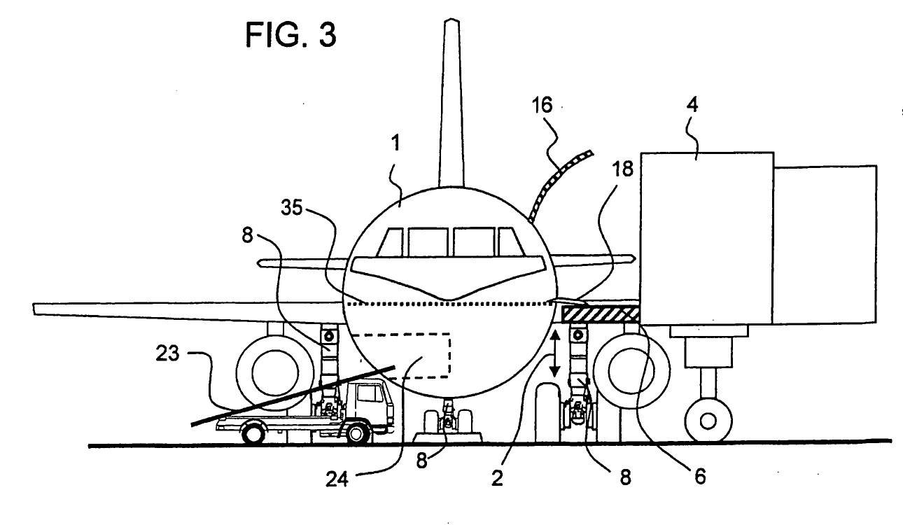

Referring now to FIG. 3, there is shown a typical commercial airliner 1 supported by landing gear struts 8. Landing gear struts 8 compress 2 as weight is added or extend 2 as weight is removed from airliner 1. Near and around airliner 1 is typical airport ground support equipment such as a passenger jet-way 4 which has a passenger jet-bridge 6 which extends to airliner passenger hatch 16. The jet-bridge ramp 18 is placed over any gap between airliner main cabin floor 35 and passenger jet-bridge 6 and restricts all but a very slight upward and downward movement of airliner 1. Extreme upward and downward movements of airliner 1 could cause severe damage to the airliner 1 and jet-bridge 6. Motorized baggage conveyor belt arm 23 also extends into airliner 1 lower baggage compartment 24. Extreme upward and downward movement of the airliner 1 could cause severe damage to the airliner 1 and the motorized baggage conveyor belt 23.

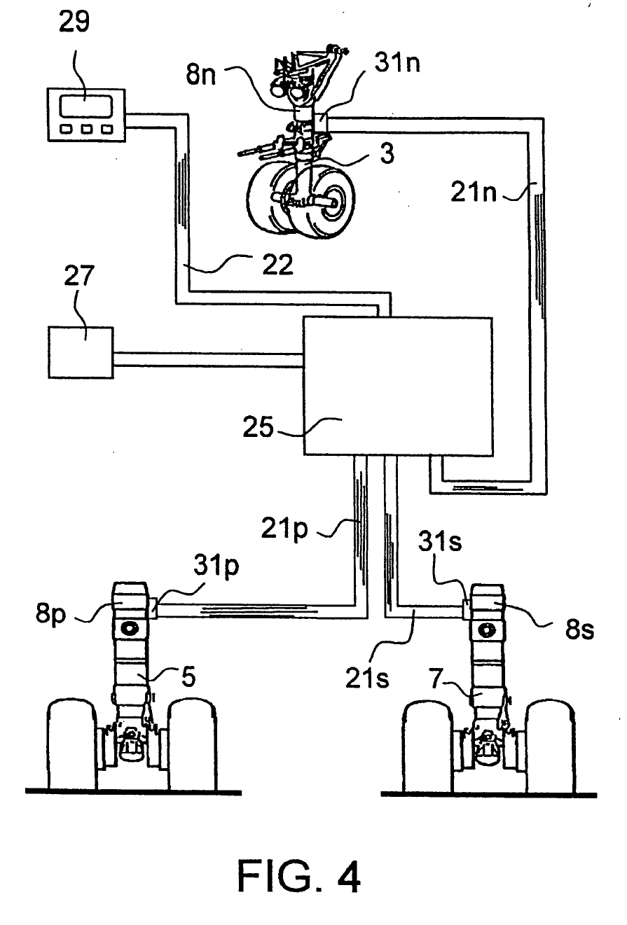

Referring now to FIG. 4, there is shown a schematic of the invention illustrating connecting components, in which “n” represents those components of the invention dedicated to the nose landing gear, “p” represents those components of the invention dedicated to the port landing gear, and “s” represents those components of the invention dedicated to the starboard landing gear. Nose landing gear 3, along with port main landing gear 5 and starboard main landing gear 7 support the weight of the airplane on a cushion of hydraulic fluid and compressed nitrogen gas. Internal strut pressure signals from each of the weight supporting struts are measured by pressure sensor assemblies 31n, 31p, 31s and transmitted via wiring harnesses 21n, 21p, 21s to an onboard computer/controller 25. The system is powered by an existing aircraft power source 27. Various calculations and information are transmitted via wiring harness 22 to an airplane cockpit or cargo compartment display 29.

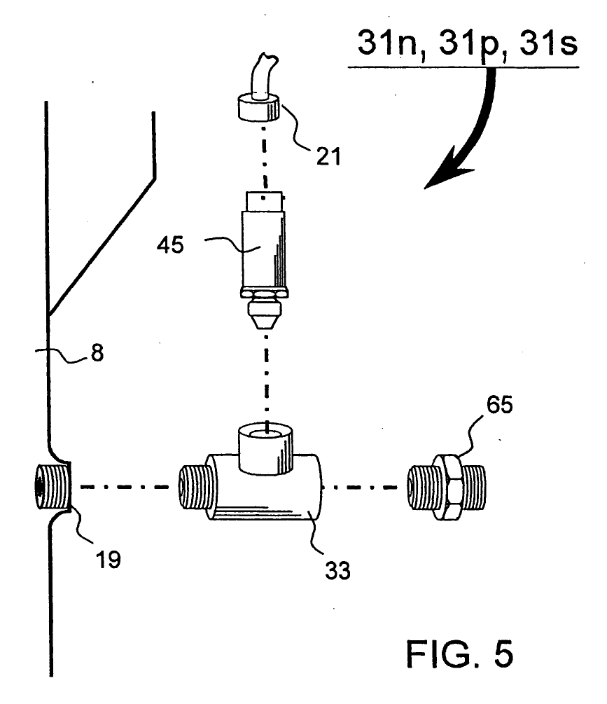

Referring now to FIG. 5, there is shown a detailed view of the embodiment of pressure sensor assemblies 31n, 31p, 31s, wherein a typical commercial airliner strut 8 incorporates a lower pressurization valve 65 attached to each strut through the fitting 19. The pressurization valve 65 is removed to facilitate the installation of a T-fitting 33. A pressure sensor 45 is connected to T-fitting 33. The valve 65 is connected to the other port of T-fitting 33. Pressure signals relative to the weight supported by the strut 8 are sent to the computer/controller 25 (FIG. 4) via wiring harness 21.

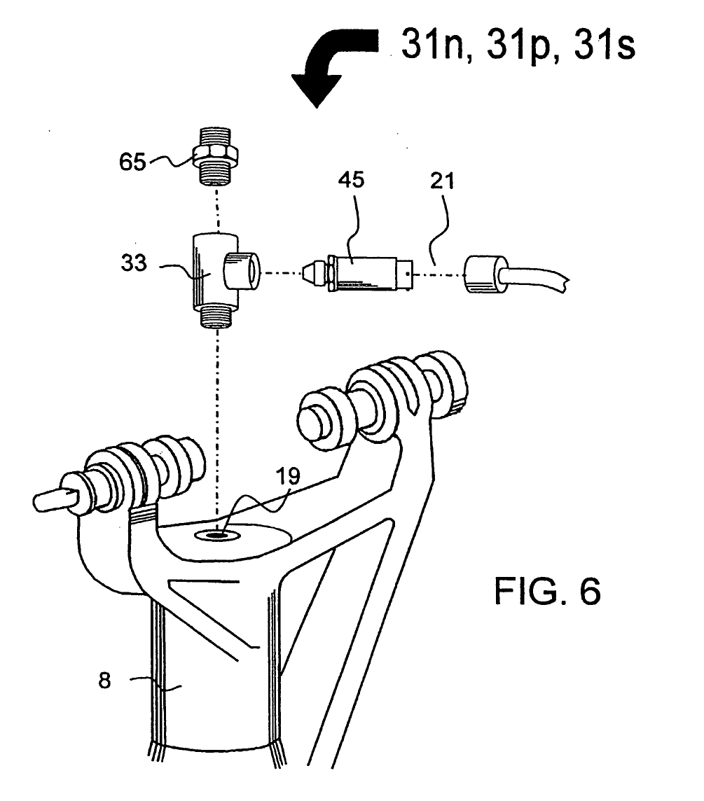

Referring now to FIG. 6, there is shown an alternate detailed view of the embodiment of pressure sensor assemblies 31n, 31p, 31s, wherein an alternate view of strut 8 which incorporates a top pressurization valve 65 attached to each strut through the fitting 19. The pressurization valve 65 is removed to facilitate the installation of a T-fitting 33. A pressure sensor 45 is connected to T-fitting 33. Pressure signals relative to the weight supported by the strut 8 are sent to the computer/controller 25 (FIG. 4) via wiring harness 21.

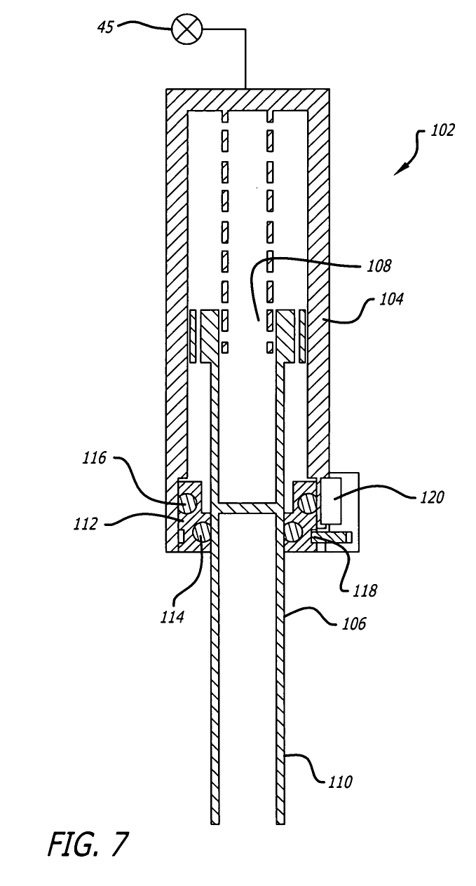

Referring now to FIG. 7, there is shown an airline landing gear strut 102 comprising elements of the preferred embodiment. The cylinder 104 of the strut holds pressurized hydraulic fluid and is connected to the body of the airplane. The piston 106 of the strut extends into the cylinder and is open at the top 108 of the piston to the hydraulic fluid. The bottom 110 of the piston is connected to the airplane landing gear. The airplane, thereby “floats” on the pressurized hydraulic fluid interface between the piston and cylinder, wherein sensor 45 is relied upon to monitor the pressure. The strut depicted in FIG. 7 may represent the nose landing gear or any of the main landing gear assemblies.

The strut seal between the cylinder and piston of the preferred embodiment is configured to rotate about the piston without moving either the piston or cylinder. The seal is housed near the lower end of the cylinder. During normal use the piston slides across the seal as it raises up when unloaded and lowers down when loaded. The seal is configured to be fluid tight while the piston raises and lowers within the cylinder so that hydraulic fluid does not leak from the strut. The seal is also configured to be fluid tight while rotating. Rotation of the seal serves to reduce friction between the cylinder and piston, and thereby reduce stiction in the strut. In the preferred embodiment illustrated in FIG. 7, a seal carrier 112 positions an inner O-ring 114 against the piston 106 and an outer O-ring 116 against the cylinder.

The rotating strut seal of the preferred embodiment has an interface 118 for interaction with a motor 120. The interface as depicted in FIG. 7 is a simple slot. The rotating portion of the motor fits within this slot and rotates the seal by means of the friction between the seal and motor. Other interfaces may include notches or teeth to match with a gear attached to a motor. Similarly a belt may attach around the rotating seal and connect to the motor. This belt may fit within a notch in the seal or otherwise. Similarly the belt may include teeth or notches to mate with corresponding structure in the seal and motor.

The motor of the preferred embodiment may be attached onto the cylinder, or be mounted within the cylinder as depicted in FIG. 7. The motor may be electrically or hydraulically powered. In a preferred embodiment, the electrical power or hydraulic pressure for the motor may be supplied by the aircraft. Similarly, the controls for the motor may also be within the aircraft. These may be located in the cockpit or in one of various service control panel on a typical aircraft. Alternatively, the electrical or hydraulic power and controls may be supplied by a separate apparatus. This apparatus may be located on a service cart which can be wheeled up to the landing gear system. In this event the landing gear strut would also include ports for electrical power, hydraulic fluid and/or control signals. Additionally an aircraft may be supplied with both on board control and power systems and portals for external power and control suystems.

In order to obtain an accurate weight of the aircraft using the present invention, the seals on each of the landing gear struts are rotated to eliminate or reduce stiction. The motors on each strut would be powered to rotate the seals about the piston. The motors may be geared to rotate the seals quite slowly. This will allow the piston to float to a state of equilibrium wherein stiction is reduced. Pressure measurements before, after and during the rotation of the seals may be taken to calculate the weight and balance of an aircraft and reduce or eliminate errors due to stiction.

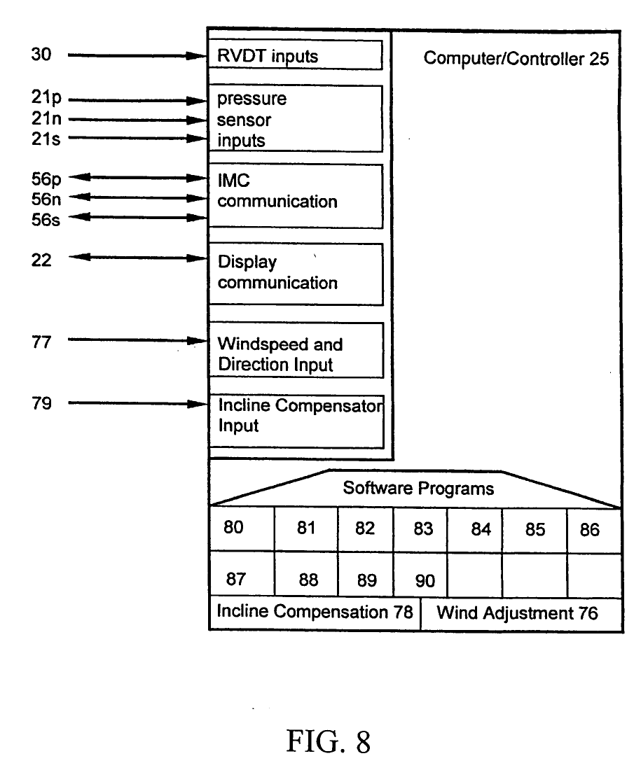

Referring now to FIG. 8, there is shown the computer/controller 25, wherein n represents those components of the invention dedicated to the nose landing gear, p represents those components of the invention dedicated to the port landing gear, and s represents those components of the invention dedicated to the starboard landing gear. Pressure input signals via the nose wiring harness 21n, port wiring harness 21p and starboard wiring harness 21s are transmitted to the computer/controller 25. Computer/controller 25 receives varying wind speed and wind direction information via wiring harness 77 from a typical externally mounted directional wind speed indicator, allowing a wind adjustment program 76 to correct the determined aircraft weight by previously measured weight errors compared to wind speed and wind direction. Wind speed and wind direction corrections are stored in the wind adjustment program 76. One method of developing wind speed correction is by placing the aircraft behind the engine prop-blast of a large turbo-prop aircraft such as a military C-130. A single or multiple C-130 aircraft will generate an external wind tunnel by increasing engine thrust. Wind speed indicators are placed at the aircraft's wing tips as the aircraft weight and center of gravity measurements are taken at different wind speeds. These weight and center of gravity measurements are related to various measured wind speeds and stored in wind speed adjustment program 76. The aircraft is rotated 15.degree. and the weight and center of gravity measurements are again related to various wind speeds which are now crossing the aircraft at a different angle. The aircraft is rotated through a complete circle, on 15.degree. increments to measure the affects of wind from all directions. Various weights are placed within the aircraft to insure the wind speed adjustments are measured at the full range of potential aircraft take-off weights. These stored values can be referenced for a particular wind speed and direction offset. This offset can be used to correct weight measurements using wind adjustment program 76.

Computer/controller 25 also receives aircraft incline information from a typical aircraft incline sensor via wiring harness 79. Aircraft incline compensation program 78 corrects determined aircraft weight for errors caused by the aircraft not being level. The calculations for strut stiction, gross weight, center of gravity, and incline compensation are performed by computer/controller 25 then transmitted to display 29 (FIG. 4) via wiring harness 22.

To determine the total weight of an airplane, with a tricycle landing gear configuration the following equation, Wt 80 must be solved:
Wn+Wp+Ws=Wt (80)

where:

Wn is the weight supported by the nose strut,

Wp is the weight supported by the port strut,

Ws is the weight supported by the starboard strut, and

Wt is the total weight of the airplane.

One method to determine the values of Wn 81, Wp 82 and Ws 83 is to solve:
[Pn.times.SAn]+Un=Wn (81)
[Pp.times.SAp]+Up=Wn (82)
[Ps.times.SAs]+Us=Wn (83)

where:

Pn is the amount of Pressure within the nose strut,

Pp is the amount of Pressure within the port strut,

Ps is the amount of Pressure within the starboard strut,

SAn is the load supporting Surface Area of the nose strut,

SAp is the load supporting Surface Area of the port strut,

SAs is the load supporting Surface Area of the starboard strut,

Un is the Unsprung weight of the nose strut,

Up is the Unsprung weight of the port strut,

Us is the Unsprung weight of the starboard strut, and

Wn is the Weight supported by the nose strut,

Wp is the Weight supported by the port strut,

Ws is the Weight supported by the starboard strut,

The equations Wt, Wn, Wp and Ws are solved by respective software programs 80, 81, 82 and 83 (see also FIG. 13).

To determine the values of Pn, Pp and Ps: These values are measured by each respective strut pressure sensor 45 (FIG. 5).

To determine the values of SAn, SAp and SAs: These values are available from the aircraft strut manufacturer.

To determine the values of Un, Up and Us: These unsprung weight values are available from the aircraft strut manufacturer. These values are the weight of the respective strut components which are not located above and supported by the hydraulic fluid and compressed nitrogen gas. These unsprung weight values include the weight of the tires, axles, brakes, hydraulic fluid, etc.

To determine the center of gravity (CG) of an aircraft the following equation CG 85 must be solved:
{[Wn.times.nl]+[(Wp+Ws).times.ml)]}.div.Wt=CG (85)

where:

Wn is the weight supported by the nose strut,

Wp is the weight supported by the port strut,

Ws is the weight supported by the starboard strut,

Wt is the total weight of the airplane,

nl is the location of the nose strut,

ml is the location of the port and starboard main struts, and

CG is the center of gravity of the aircraft.

The equation to determine the aircraft CG is solved by software program 85.

Irregardless of the loading configuration of a particular aircraft nl and ml are known constants; Wn, Wp, Ws and Wt are values provided through the solution to the equations 80-83 to determine the total weight of the airplane.

An additional computer/controller program 86, which indicates wing-lift distorting ice accumulations as well as changes in aircraft weight due to those ice accumulations, is available as an option. As a reference, the weight of a cubic foot of ice is stored into the memory of this program (this weight equals 12 square feet of ice 1 inch thick, or 48 square feet of ice ¼ inch thick, etc.). The total exterior surface square footage, of that particular aircraft, on which ice can accumulate is determined and also stored in the permanent memory of this program. As an alternative, tables may be supplied by the aircraft manufacturer relating ice thickness as a function of weight gains on that particular aircraft. Once the aircraft loading has been completed and all deicing procedures have been implemented, the pilot can then save within this program, the aircraft's current “clean loaded weight”. If take-off delays force the aircraft to wait and allow the re-accumulation of ice deposits on exterior surface areas, those accumulations can be indicated in real time as they relate to added weight shown on this invention. The pilot may recall the “clean loaded weight” and compare it to existing weight, less any fuel burn, at any time prior to take-off When an aircraft is sprayed with de-icing fluid the aircraft weight increases in direct proportion to the weight of that de-icing fluid. The weight of the average volume of de-icing fluid used to de-ice a particular aircraft type, can be measured and stored into a de-ice program 87. Similar procedures as those described in “de-ice” program 87 are performed to generate a “rain weight” program 90, for measuring and offsetting the weight of water accumulations on the exterior surfaces of the aircraft. De-icing fluid is in the form of a thick gel where water is not. The weight of water accumulations on the exterior surfaces of the aircraft are less than that of de-icing fluid. When the aircraft is approaching take-off speeds, water or de-icing fluid and residual ice on the aircraft, as well as their weight, will blow off of the aircraft, making the aircraft lighter than originally measured. The pilot can properly adjust downward the measured weight of the aircraft through the implementation of de-ice program 87, or if weather conditions dictate, “rain weight” program 90. A detached computer/controller 25 may be used as an off-aircraft portable system.

What is claimed is:

1. A strut for supporting an aircraft, comprising:
a cylinder defining a central axis;
a piston telescopically disposed within said cylinder;
a seal for maintaining a fluid-tight seal between said cylinder and piston; and
a mechanism for rotating said seal about said central axis.

2. The strut of claim 1, wherein said seal comprises an O-ring.

3. The strut of claim 1, wherein said mechanism for rotating said seal comprises a rotatable seal carrier disposed between said cylinder and said piston and configured to urge said seal against said piston.

4. The strut of claim 3, wherein said mechanism for rotating said seal further comprises a motor for rotating said carrier.

5. The strut of claim 4, wherein rotation is transferred from said motor to said seal carrier by friction.

6. The strut of claim 4, wherein rotation is transferred from said motor to said seal carrier by gears.

7. The strut of claim 4, wherein rotation is transferred from said motor to said seal carrier by a drive belt.

8. The strut of claim 3, further comprising a second seal disposed between said seal carrier and said cylinder.

9. The strut of claim 8, wherein said second seal comprises an O-ring.

10. The strut of claim 1, further comprising a fluid contained within said cylinder that is subject to pressurization upon extension of said piston into said cylinder and a sensor for measuring pressure of said fluid.

11. The strut of claim 10, wherein said fluid comprises a combination of hydraulic liquid and a compressible gas.

12. The strut of claim 10, further comprising a computer for converting said measured pressure to a weight supported by said strut.

13. A method of measuring weight supported by a strut, wherein a piston, defining a central axis, is telescopically received within a cylinder to pressurize a fluid therein and wherein a seal is disposed between said piston and cylinder, comprising:
rotating said seal about said central axis; and
measuring the pressure of said pressurized fluid.

14. The method of claim 13, further comprising converting said measured pressure to a weight supported by said strut.

15. The method of claim 14, wherein said fluid comprises hydraulic liquid and a compressible gas.

16. The method of claim 13, wherein said seal is rotated by actuation of a motor.

17. The method of claim 16, wherein said motor is affixed to said cylinder.

18. The method of claim 16, wherein said seal is urged against said piston by a seal carrier that is rotationally engaged to said motor.

19. The method of claim 18, wherein a second seal is disposed between said seal carrier and said cylinder.

20. The method of claim 19, wherein said seals comprise O-rings.
